(19) United States
(12) Patent Application Publication
(10) Pub. No.: US 2017/0165680 A1
(43) Pub. Date: Jun. 15, 2017

(54) ELECTROSTATIC MEDIA FILTER

(71) Applicants: Michael Johnson, Tacoma, WA (US); Ed Minger, Puyallup, WA (US); Caleb Payne, Auburn, WA (US)

(72) Inventors: Michael Johnson, Tacoma, WA (US); Ed Minger, Puyallup, WA (US); Caleb Payne, Auburn, WA (US)

(21) Appl. No.: 14/964,452

(22) Filed: Dec. 9, 2015

(51) Int. Cl. B03C 5/02; C02F 1/48

(52) U.S. Cl. CPC B03C 5/02; C02F 1/48; C02F 2201/48

(57) ABSTRACT

The electrostatic media filter includes a treatment vessel having an inlet and an outlet, with at least one anode and cathode pair within the treatment vessel, along with a source of potential connecting the anode and cathode pair. A granular media filter is positioned in the treatment vessel such that as water flows through the media layer, suspended particles are captured in the media or by electrostatic attraction.

### Technical Field

The present invention relates to a water treatment apparatus, and more particularly, to a filter/reactor for reducing pollutants in water and wastewater, including suspended particles, dissolved metals and ionic materials by imposing an electric charge and or electric field within a filtration media.

### BACKGROUND OF THE INVENTION

The need for a better and more reliable means of water treatment has been a long-term historical challenge. In modern industry, the basic need for clean water and the need to comply with regulations have become especially challenging when applied to non-point sources, which may contain a variety of dilute pollutants that vary significantly over time. In particular, the removal of suspended solids and charged ionic species is useful for disturbed areas, mining operations and construction sites. The electrostatic media filter (EMF) disclosed herein is a tool to achieve these ends.

Finely divided suspended solids are difficult to manage by traditional filtration in water treatment systems. Suspended solids are often made of particles too small for media filters, and comprised of particles with mutually repulsive surface charges, such as those found on finely divided silicate clays. Mutually repulsive forces occur in many soils comprised of substances like silicon dioxide matrices, where the exterior of the structure has a slightly negative electrical charge. These negative charges repel each other, much like the negative ends of a bar magnet repel one another. These repulsive forces are stronger than gravity, so the particles do not settle or settle very slowly.

Water molecules are comprised of two hydrogen atoms and one oxygen atom, arranged with a bond angle of 104.5 degrees. The tendency for atoms to attract electrons is referred to as “electronegativity.” Oxygen is highly electronegative, and has much more affinity to hold onto negatively charged electrons. Because the water molecule is asymmetrical and the oxygen carries a negative charge, the water molecules are considered ‘polar.’ In chemistry, substances that are polar, ionic or semi-polar tend to be water-soluble. Electrical charges on any scale, from particles to molecules, can attract or repel one another.

Many pollutants, like suspended particles, are comprised of complex molecular structure. Particles from soils are often silicate structures, where the outer atoms of the crystal structure are oxygen. As discussed above, oxygen tends to have negative charge because it is more electronegative than silicon and carbon. This means that particles often have mutually repulsive electrical forces, like the negative ends of bar magnets. These forces far exceed that of gravity, which otherwise would allow the particles to precipitate. As a result, these particles tend to remain suspended.

There are many different types of water treatment filters and reactors. Media filtration, especially sand filters, activated carbon and anthracite filters are common. Electrocoagulation is a method known for treating suspended solids using electrical current, typically by dissolving metallic species into solution and forming cations to initiate formation of colloidal particles. The existing systems rely on solely mechanical filtration or other structural arrangements for physically capturing particles. Sand filters are only effective for particles greater than 20 microns. Particles less than 20 microns pass through. Smaller or more finely divided media have been used, but these are frequently subject to clogging. Electrocoagulation requires extensive infrastructure, sacrificial anodes and/or chemicals to achieve the same ends.

### SUMMARY OF THE INVENTION

Accordingly, the electrostatic media filter for treatment of wastewater, comprises: a treatment vessel having an inlet and an outlet; at least one anode and cathode pair; a source of potential connecting the anode and cathode pair; and a media layer, positioned such that in operation, the media layer functions as a mechanical filter, with the anode and cathode pair forming an electric field, and/or conductive surfaces within the media to capture pollutants from the water entering through the inlet, with treated water exiting through the outlet.

### BRIEF DESCRIPTION OF THE DRAWINGS

FIG. 1 is a first embodiment of the electrostatic media filter of the present invention.

FIG. 2 is an alternative embodiment to FIG. 1.

FIG. 3 is a further embodiment of the media filter.

FIG. 4 is a system involving a plurality of treatment vessels and a collection/detention system.

### BEST MODE FOR CARRYING OUT THE INVENTION

The invention is the result of investigations related to the treatment of turbid water, using electrode pairs imbedded in granular media. Soils in many areas do not settle due to mutually repulsive electric charges on their exterior. Precipitation of the particles requires disruption of the repulsive forces.

Passing water through a media bed minimizes the mean-free-path of the suspended particles to be attracted by the bed media. Use of soluble anodes within the treatment vessel may be used to augment the effect. Soluble anodes generally yield cations capable of attracting suspended anions, effectively forming larger particles as in electrocoagulation systems. Imbedding electrocoagulation technology within the filter vessel in the process is another feature that may enhance the performance of the filters.

In addition, recirculation of the water back through the electrostatic media filter (EMF) vessels improves the overall removal efficiency of the system, since each pass will reduce the amount of suspended solids. Use of a detention tank or accumulation tank in-between recirculation steps allows particles to coagulate and larger colloids to form, thereby increasing filtration efficiency. Detention of six minutes or more is generally the threshold for adequate colloid formation and recirculation.

Imposing a low positive voltage (typically <20V) on or around the media bed improves the capture of charged particles and ions. Due to the large surface area within the media beds, the media may be selected or modified to provide binding sites that are enhanced by electrical charge or electrical fields. The energy required (amperage) is far less than traditional plate-type electrostatic systems designed to accomplish the same treatment results, as in electrostatic precipitators in air pollution systems.

The ability for the invention to improve the collection of suspended particles is apparent. The system can be modified in many ways to affect treatment of other pollutants. For example, imposing a negative charge on a media bed will selectively attract positively charged ions, such as multivalent heavy metals.

Initial bench scale experiments have been completed using anthracite as the charged media with an aluminum bar as the anode situated above the media bed. An anthracite bed in tap water showed a resistance of 40 Ohm—which is moderately conductive.

In the test, a water sample was prepared using sand wash water. The system was constructed for gravity testing, but pressure systems work comparably at higher flow rates. The basis for comparison was a single pass through the media bed with no electrical power or recirculation. The water sample flowed downward through a plastic pipe, such that an aluminum anode at the top of the bed was electrically isolated from the conductive anthracite and carbon fiber bed. A conductive bar was attached to the interior of the pipe, providing electrical continuity through the entire depth of the bed. The base of the bed was comprised of ¾″ crushed rock, approximately six inches deep, followed by 12″ of screened sand, nominally 0.3 mm-0.4 mm diameter. The water passes vertically over the cathode, through the conductive bed, then through the conductive layer, sand, gravel and screen.

Any number of configurations for the electrostatic and electrocoagulation functions is possible. Using multiple alternating layers of conductive material is expected to yield improved results. Different media with different densities will tend to segregate during backflush operation. Fixed bed structures of conductive materials (e.g. metal screen, wool or carbon fiber) separated by nonconductive layers (sand) also provides the ability to target specific pollutants for electrostatic attraction or electrochemical reaction. The invention relates to all forms of conductive beds used for the removal of pollutants from water and wastewater.

Backflush operations are enhanced by either turning off the current or reversing polarity during backflush operations.

Other physical configurations of the EMF include imposing an electric field within a media (sand) filter by imbedding conductive electrodes in a predetermined pattern to achieve specific results for different pollutant species.

Recirculating the water through the filter beds multiple times has been shown to improve treatment efficiency. This effect is increased when there is a detention period between filtration steps to allow colloid formation.

The electrostatic charges on particles change as they pass through the media beds. The recirculation of water repeatedly through media filter, with a short pause in between steps, allows colloids to form and enhances the performance of the system. This provides a means for larger colloids to form between filtering steps. The invention includes recirculating the treated water through charged or uncharged media beds, and detaining the treated water prior to recirculating to allow for colloid formation and larger charged particles to form. This step has been shown to enhance performance of recirculating systems. Recirculation of water through sand filters with a designed period of detention as unique, useful and affects treatment.

An objective of the invention is to provide an electrostatically charged media filter that captures particles both mechanically and by use of electrical charge and/or electrical fields. The invention also may include sacrificial and non-sacrificial electrodes placed within filter media to impose an electrical charge and/or electrical field within the filter media, such that pollutants are captured at both the macro level for particles and the molecular level (using Vander Waals forces).

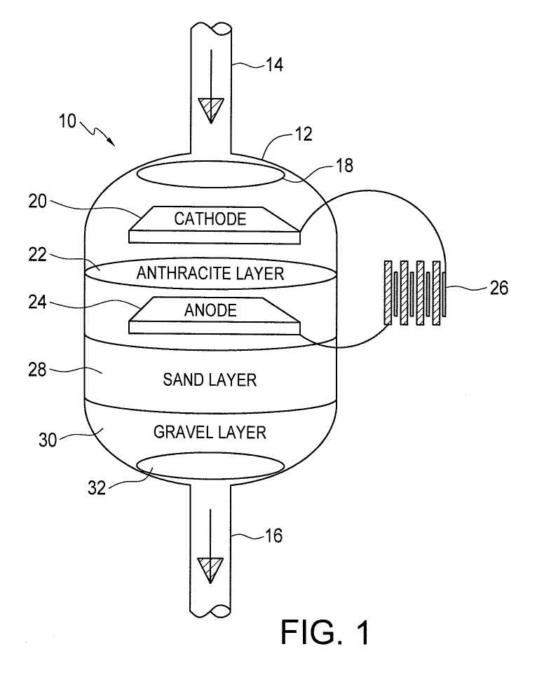

FIGS. 1-4 show a variety of structures for the present invention. Anodic and cathodic systems (electrode pairs) in contact with or surrounding the filtration media in the presence of a conductive electrolyte (e.g. water, wastewater or stormwater) provide an electrical charge that increases the efficacy of filtration. The electrodes and filtration media can be arranged in a variety of structures and placed in the path of dissolved ionic species, where mechanical filtration, electrostatic attraction, desirable oxidation/reduction reactions, electrocoagulation and colloidal formation can occur. These result in the capture of suspended and dissolved pollutants.

The invention can be utilized in pretreating water supplies, used in stormwater treatment systems, industrial wastewater treatment systems, and in the treatment of agricultural wastes, oil, gas and mining wastes and other related industries.

The advantage of the present invention approach is that the water to be treated must flow through the filtration media that is enhanced by the electrical charge produced by electromagnetic fields, thereby increasing the ability to capture charged particles and improving treatment efficiency. Sacrificial anodes may be included within the system to enhance the formation of colloidal particles.

Generally, the reactor filter is comprised of an exterior vessel or tank that may be pressurized or gravity fed, within which is a conductive anode separated from a conductive cathode with a charge or electromagnetic field imposed on filtration media. A non-conductive dielectric material may be present to separate the anode from the cathode, or layers of non-conductive media (sand) may be use to separate the electrode pairs. One or more types of filtration media are employed within the vessel, such as sand, anthracite, activated carbon, biochar, gravel, bauxite, aluminum oxides, garnet, or other filter media. These may be coated with conductive materials to enhance the distribution of the electromagnetic charge.

The cathode and anode may be constructed of two or more dissimilar metals. When the current is not applied to the system, this can result in an intrinsic potential between the dissimilar metals in the presence of an electrolyte, resulting in the dissolution of the metal higher in the galvanic series. This dissolution is desirable in reactions that require specific metal species (such as aluminum) to precipitate particles or reduce dissolved species. As a result, the reactor in the un-powered state acts as a galvanic cell battery and electrochemical reactor.

FIG. 1 shows a first embodiment of the media filter 10. The media filter includes a vessel 12 with an inlet 14 at the top and an outlet 16 at the bottom. The vessel can be various sizes. At the top of the vessel is a distribution manifold 18, followed by a cathode 20, a layer of anthracite coal 22 and an anode 24. In the embodiment shown, the first media layer of anthracite coal is approximately 12 inches deep, sized and screened to approximately 0.3-0.4 mm in diameter. This can be varied. A potential is present between the cathode and the anode provided by battery 26. In the embodiment shown, the potential is approximately 24V. Below the anode is a sand layer 28 followed by a layer of gravel 30 and a collection manifold 32 at the bottom of the vessel.

In the embodiment shown, the sand layer is approximately is approximately 12 inches thick and has the same size particles as the anthracite coal. Again, this can be varied. The bottom layer comprised of pea gravel or chicken scratch grit is normally 5 mm-10 mm in diameter. The collection manifold 32 is made up of a series of slotted pipes to collect the water for discharge out the outlet of the vessel. The system may comprise two or more electrode (anode/cathode) pairs. If modified to the system, the result can be an intrinsic potential between the dissimilar metals in the presence of electrolytes, resulting in dissolution of the metal higher in the galvanic series. This dissolution is desirable in reactions that require specific metal species, such as aluminum, to precipitate particles or reduce a dissolved species. As a result, the reactor in the unpowered state acts as a galvanic cell battery and electrochemical reactor.

More particularly, the EMF media may be granular or fibrous. In some cases, the media may be conductive material, carbon-based, mineral based or manufactured. In other cases, the filter media may be non-conductive, intrinsically conductive or coated with conductive material. Media may be a mixture of conductive and non-conductive material. One or more of the conductive electrodes or media layers within the EMF vessel may be used as a sacrificial anode through or around which water can flow. Some of the layers of non-conductive material may be used to electrically isolate the conductive layers. The electrodes may be comprised of pervious conductive layers such as non-woven fibers, screen material, granular materials, woven materials or perforated sheets. In some applications, the conductive materials may be comprised of dissimilar metals or non-metallic conductors in contact with one another in such a way that an electrical potential is created in the presence of an electrolyte. This forms an internal galvanic cell in the presence of an electrolyte within the EMF. As pollutants are comprised of ionic material, they comprise part of the electrolyte. More ionic pollutant generally increases the galvanic effects and efficacy of treatment.

The EMF vessel may have a solid body, such as plastic or metal capable of withstanding pressure or gravity; which may include an inlet valve for regulating the flow of water; and which may include an orifice or valve for regulating the outgoing flow of water. The direct current (DC) power supply is capable of producing electrical current with the positive electrode electrically connected to the anode and a negative electrode electrically connected to the cathode.

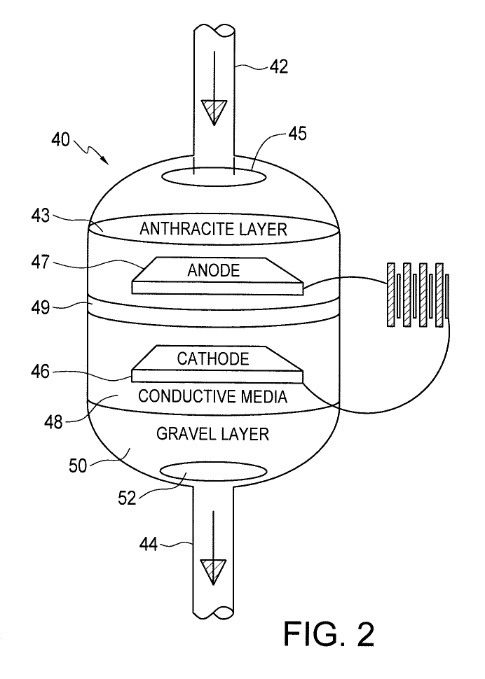

FIG. 2 shows another embodiment, involving a vessel 40 with a pressurized feed inlet 42 and an outlet 44. Within the vessel is a distribution manifold 42, an anthracite layer 43, an anode 44, a layer of dielectric material and a cathode 46. A layer of conductive material such as metal shot 48 is located beneath the cathode, followed by a gravel layer 50 and a collection manifold 52, similar to that of the embodiment of FIG. 1.

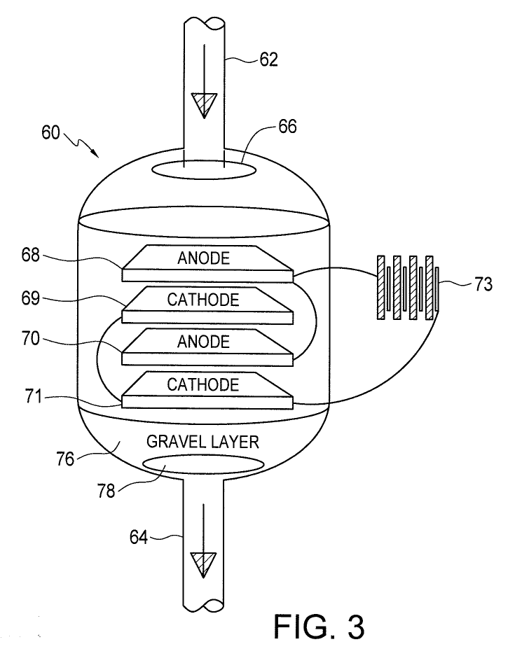

FIG. 3 shows a further embodiment involving a reactor vessel 60 with an input 62 at the upper end and an outlet 64 at the lower end. At the top end of the vessel is a distribution manifold 66 similar to the other embodiments. In the vessel are alternating anode and cathode elements 68-71 with a DC potential produced by a battery 74. Below the cathode 71 is a gravel layer 76, followed by a collection manifold 78 at the bottom of the vessel.

The above three embodiments show three basic reactor vessel approaches but are not intended to be exclusive. Any combination of one or more anodes and cathodes in the media filter arrangement, with or without dielectric areas and with or without conductive media, are suitable/appropriate. Soluble or sacrificial anodes may also be used.

A “backflush” operation can be used to clean the captured pollutants from the media in the various embodiments. In backflush, the direction of water flow is reversed by means of valves and piping manifolds to accomplish removal of pollutants of the media. The current can be turned off for backflushing the meda or the polarity of the media beds can be reversed for backflushing of the media beds. Flow to the EMF vessel is ceased and treated water is caused to flow backwards through the media beds. The backflush water is diverted to a holding tank to capture the pollutants for disposal. The pollutants settle by gravity in the backflush tank and the supernatant is retured to the beginning of the process for treatment.

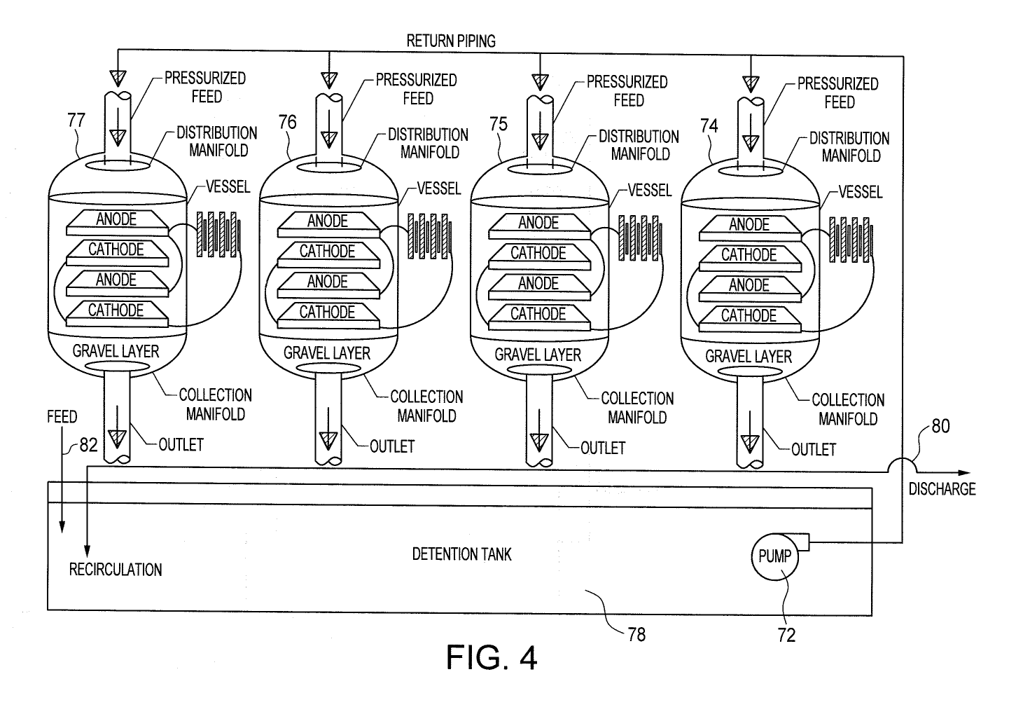

FIG. 4 shows a recirculation/detention arrangement involving a plurality of similar reactor vessels. Water for filtering is held in the detention tank 70. A pump 72 directs water to each of the plurality of reactor vessels 74-77. Each reactor vessel has the same arrangement as shown in FIG. 3, but they could also utilize other embodiments as well. This arrangement allows water to be recirculated if necessary for additional cleaning prior to discharge through outlet 80. Additional water to be treated can be added through an input feed line 82.

Although a preferred embodiment of the invention has been disclosed for purposes of illustration, it should be understood that various changes, modifications and substitutions may be incorporated in the embodiment without departing from the spirit of the invention, which is defined by the claims which follow.

What is claimed is:

1. An electrostatic media filter assembly for treatment of wastewater, comprising:
a treatment vessel having an inlet and an outlet;
at least one anode and cathode pair;
a source of potential connecting the anode and cathode pair; and
a media layer, positioned such that in operation, wherein the media layer functions as a mechanical filter, with the anode and cathode pair forming an electric field, and/or defining conductive surfaces within the media to capture pollutants from the water entering through the inlet, with treated water exiting through the outlet.

2. The media filter assembly of claim 1, wherein the media filter comprises a granular material.

3. The media filter assembly of claim 1, including a plurality of anode/cathode pairs with the source of potential connecting each anode pair.

4. The media filter assembly of claim 1, including wherein the anode/cathode pairs are positioned within or in proximity to the filter media layer.

5. The media filter assembly of claim 4, wherein the filter media comprises sand, anthracite coal or carbon material.

6. The media filter assembly of claim 1, including one or more electrically conductive layers or electrically non-conductive layers.

7. The media filter assembly of claim 1, wherein the water to be treated proceeds via gravity through the treatment vessel.

8. The media filter assembly of claim 1, wherein the water to be treated is directed under pressure into the treatment vessel.

9. The media filter assembly of claim 1, wherein the media has a size of 0.3 mm-0.4 mm in diameter.

10. The media filter assembly of claim 1, including a layer of pea gravel positioned at a lower end of the treatment vessel.

11. The media filter assembly of claim 1, wherein the treatment vessel includes a distribution manifold at a top end of the treatment vessel and a collection manifold at a bottom end thereof.

12. The media filter assembly of claim 1, wherein the treatment vessel includes a dielectric layer between one or more of the anode/cathode pairs.

13. The media filter assembly of claim 1, including a detention/recirculation tank, with a pump to move water from the tank into inlets for one or more treatment vessels.

14. The media filter assembly of claim 13, wherein treated water from the one or more treatment vessels can be discharged, or can be directed back onto the detention tank for additional treatment.

15. The media filter assembly of claim 13, including an inlet to receive incoming untreated water into the detention/recirculation tank.
